(19) United States
(12) Patent Application Publication
(10) Pub. No.: US 2012/0079278 A1
(43) Pub. Date: Mar. 29, 2012

(54) OBJECT SECURITY OVER NETWORK

(75) Inventors: Raymond R. Patch, Redmond, WA (US); Liviu F. Tiganus, Sammamish, WA (US); Daniel K. Lin, Redmond, WA (US)

(73) Assignee: MICROSOFT CORPORATION, Redmond, WA (US)

(21) Appl. No.: 12/892,870

(22) Filed: Sep. 28, 2010

(51) Int. Cl. G06F 21/20

(52) U.S. Cl. 713/182; 726/4

(57) ABSTRACT

The application to a security model to one or more objects that are located on a network. When an object is to be accessed, security data associated with the object is accessed and enforced against the object. For instance, the security data might be used to determine an authentication mechanism to use to authenticate the user or entity that is accessing the object. The security data might also correlated the authenticated user or entity to the authorized actions that may be performed by that entity on the object. The security data might also specify encryption policy regarding the object.

### BACKGROUND

In object-oriented programming, an application is given functionality through the interaction of data structures called “objects”. Each object is capable of sending and/or receiving messages, and processing data. To facilitate interaction and processing, each object contains zero or more properties and zero or more methods. Objects may interact by one object placing a function call on methods of another object, and accessing property values from another object. During execution of an object-oriented program, objects are instantiated in the local memory of a computing system, and perform interactions in memory. Objects may also be located on a network and accessed over the network.

### BRIEF SUMMARY

At least one embodiment described herein relates to the application of a security model to one or more objects that are located on a network. When an object is to be accessed, security data associated with the object is accessed and enforced against the object. For instance, the security data might be used to determine an authentication mechanism to use to authenticate the user or entity that is accessing the object. The security data might also correlate the authenticated user or entity to the authorized actions that may be performed by that entity on the object. The security data might also specify encryption policy regarding the object.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 abstractly illustrates a computer network in which an application may access a remotely instantiated object;

FIG. 3 abstractly illustrates an object having methods and properties, and which represents an example of one of the objects of FIG. 2;

FIG. 4 abstractly illustrated security information that may be maintained by the security intervention mechanism of FIG. 2; and

FIG. 5 illustrates a flowchart of a method for providing security intermediation between an application and plurality of objects that are instantiated remotely from the application, and which may be performed by the security intervention mechanism of FIG. 2.

### DETAILED DESCRIPTION

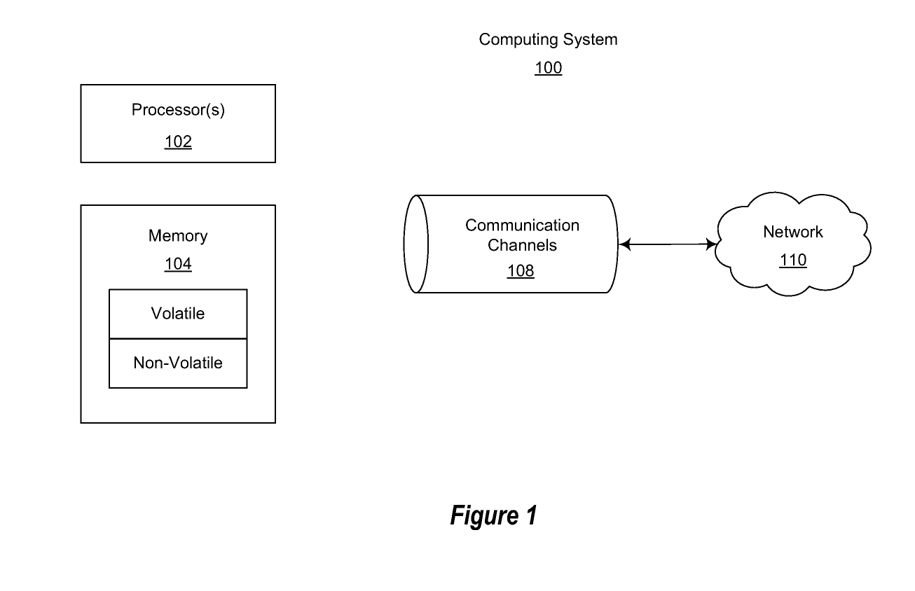

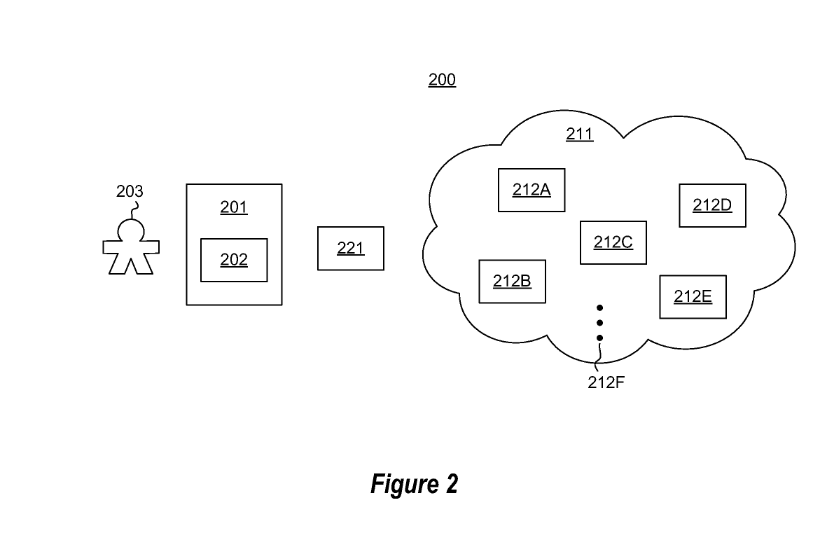

In accordance with embodiments described herein, a security model is applied to one or more objects that are located on a network. When an object is to be accessed, security data associated with the object is accessed and enforced against the object. First, some introductory discussion regarding computing systems will be described with respect to FIG. 1. Then, the embodiments of the object-based security model will be described with respect to FIGS. 2 through 5.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a computer network 200 that includes a plurality of computing systems. One of the computing systems 201 is shown in FIG. 2 and may be structured as described above for the computing system 100 of FIG. 1. The computing system 201 is running an application 202 and may optionally be running at the direction of a user 203. The computer network 200 also includes an instantiation platform 211. The instantiation platform 211 may be a memory of one of the other computers in the network. In the case of a distributed instantiation platform 211, the instantiation platform 211 may be the memory of multiple other computing systems in the network 200. The network 200 may be, for example, a local area network such as an intranet. Alternatively or in addition, the network 200 may be a wide area network such as, for example, the Internet.

The instantiation platform 211 is located remotely from the computing system 201 in that the computing system 201 must communicate over the network in order to communicate with the instantiation platform 211. The instantiation platform has instantiated thereon a number of objects referred to collectively as objects 212. For instance, in FIG. 2, five objects are illustrated including objects 212A, 212B, 212C, 212D and 212E. However, the ellipsis 212F represents that there may really be any number of objects from as little as one, to as many as enumerable, that are instantiated on the instantiation platform 211.

The application 202 running on the computing system 201 (and potentially any application having access to the instantiation platform 211) may potentially request access to any one or more of the objects 212. To provide appropriate security in such access, a security intervention mechanism 221 intervenes between the application (such as application 202) and the objects 212, and is used by the application to provide security between the application and the object. The security intervention mechanism 221 may run on one of the computing systems in the network 200, or may perhaps be distributed throughout multiple computing systems.

Each of the objects may contain zero or more methods, and zero or more properties. A method of the object may be called by another method within the object, or perhaps through a function call from other objects. Likewise, execution of a method may cause the object to send function calls to other objects. The objects may perform processing in response to a message or other event, and thereby potentially alter one or more of its property values.

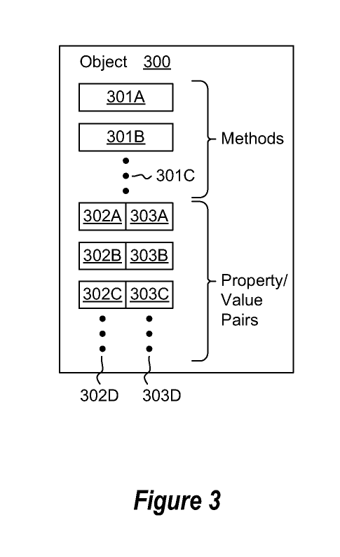

FIG. 3 abstractly illustrates a data structure of at least one of the objects 300 that is instantiated in the instantiation platform 211, and which is used by the application. In this case, the object has two methods 301A and 301B, although the ellipsis 301C represents that there may be any number (zero or more) methods. The object 300 is also illustrated as including properties 302 and corresponding property values 303. For instance, property 302A has value 303A, property 302B has value 303B, and property 302C has value 303C. The ellipses 302D and 303D represent, however, that there may be any number of properties (one or more) and associated values. In a hierarchical object model, the property value may indeed be an entire other object.

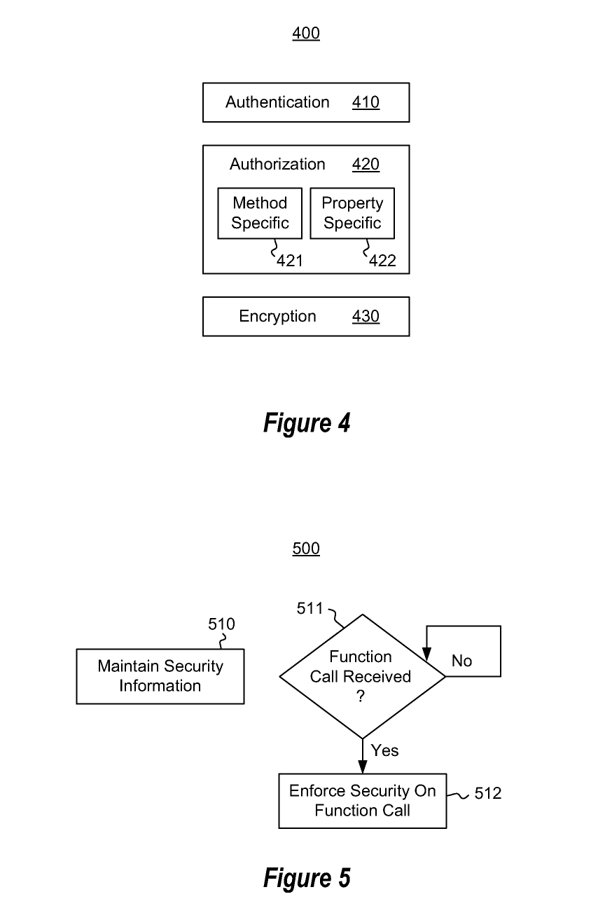

FIG. 4 abstractly illustrates security information 400 that may be maintained by the security intervention mechanism 221 for each object. The information includes authentication information 410 that permits the security intervention mechanism 221 to enforce an authentication of the application or a user of the application before providing the application access to the object. As an example, the authentication information 410 might include the manner in which authentication is to occur, and information that will allow identity to be verified under that authentication mechanism.

Authorization information 420 correlates access rights for the objects to specific identities. The access rights might not only specify whether the authenticated identity has access to the object, but also what kind of access. The access rights might even get to the level of being method specific authorization 421. For instance, referring to FIG. 3, the access rights may indicate that a specific user has authorization to execute method 301A, but not method 301B. Alternatively, the access rights may indicate that a specific user has authorization to execute both methods 301A and 301B, or neither method 301A nor 301B. The access rights may also include property specific authorization 422. For instance, referring to FIG. 2, the property specific authorization 422 might indicate that a particular authenticated user may have read access to property 302A, but write access to property 302B, and no access at all to property 303C.

The encryption information 430 allows the security intervention mechanism to enforce an encryption protocol for the object. For instance, the encryption protocol might indicate whether or not a property value of a property should be encrypted as communicated over the network, or even as kept in the object itself. The encryption protocol might also specify whether or not other message (such as function calls, or function call returns) whether received by, or transmitted by, the object should be encrypted.

FIG. 5 illustrates a flowchart of a method 500 for providing security intermediation between an application (such as application 202) and the plurality of objects 212 that are instantiated remotely from the application. The method 500 may be performed for each object. Security information is maintained (act 510) for each of objects. If a function call is not received (No in decision block 511), then nothing further needs to be done at that point. However, if a function call is received (Yes in decision block 511), then the security information is enforced on the function call (act 512). For instance, the entity making the function call is authenticated in accordance with authentication information 410, and the access rights of the authenticated entity are evaluated using the identity of the object to which the function call is being placed and its corresponding authorization information 420. In complying with the function call, the encryption policy 430 of the object is followed. The act 510 is shown apart from the function call response methodology of acts 511 and 512 to emphasize that these could be parallel processes.

A specific code example will now be provided in which the security information helps to apply access control information with an object. This information will be associated with both the object as a whole, as well as with its properties and methods, in a hierarchical way, where the access control information for the objects is inherited by the object properties and methods, with the option of overriding that information at the down level, thus being able to set different security options for the object properties or methods. Once this information is set on the object, whenever access through an operation is performed on the object, the access control will come into place and be enforced.

Securing objects can also be seen in the context of the ObjectNamespace where those objects are stored. In this context objects will also be able to inherit the access control information from their container, in this case from a namespace in which the object is saved. For example, suppose there is a Customer object instance. Access to this object may be restricted by updating or adding access control information to the authorization information for the object instance. For instance, suppose the Customer object instance had a CreditCardNumber property. Access to credit card numbers should be carefully controlled. The following pseudo code may be used to create the Customer instance.

//
// Connect to the Object Namespace service
//
ObjectNamespace objectNamespace = ObjectNamespace.Connect( );
//
// Create a Customer instance
//
Customer customer = new Customer( );
//
// Populate Customer instance
//
customer.FirstName = “Fred”;
customer.LastName = “Barnes”;
customer.CreditCardNumber =“1111-1111-1111-1111”;
//
// Write the Customer instance to Object Namespace
//
objectNamespace.Write(

“RetailCustomer”,
WriteOptions.None,
customer
);

In the above sample, there are two aspects of note. First, the access control happens at the time the object was written, when the writing entity can be allowed to write objects, or where the writing entity may be denied to write objects to the namespace. The second aspect is that at this time, access control information has been associated with the Customer objects that are saved, a default one for the Customer object, as well as the inherited access control information from the namespace object we saved the object into.

Full access to the object can be granted by default to the user that created the object, and possible to an administrator group. All access for other users could perhaps be denied as a default setting.

In this case, if the writing entity were to retrieve the object instance, this will be possible using, for example, the following call.

Customer customer = objectNamespace.Read(

“RetailCustomer”
);

For example if User2 is a user account part of an administrator group, this user will be able to retrieve the object, by the fact that it is part of the Administrator group, which, by default, was granted access to the object.

If another user, User3, that was not specifically granted access to the Customer object and is not part of the Administrator group, tries to read the Customer object, the User3 will get an AccessDenied response, at least until access is granted for that user, or a group that user is part of.

Access to the object may be restricted based on specific access rights. For example User4 can have read access to the Customer object but would get the AccessDenied response if trying to update the object, meaning that the user does not have write access.

The updating of the access control information for an object starts with retrieving the object security information and then adding to or removing from access control info, using for example the following code.

ObjectSecurity customersecurity = objectNamespace.GetAccessControl(

customer
);

ObjectRight writeRight = ObjectRight.Write
customerSecurity.Add

writeAccess
);

objectNamespace.SetAccessControl(

“RetailCustomer”,
customerSecurity
);

Another aspect of securing objects is to allow access control for an object's properties or methods. Based on the Customer object sample, it may be desirable to restrict access to the CreditCardNumber property only to certain users, thus somebody that can read the object might not be able to read the property.

The following pseudo code would work, and the user will get access to the customer instance:

Customer customer = objectNamespace.Read(

“RetailCustomer”
);

While trying to access the credit card number property will result in an AccessDenied response/exception:

// Exception will be thrown here as access will be denied
String number = customer.CreditCardNumber;

In one embodiment, when access is denied to a property, an AccessDenied response/exception is not given in this example implementation. Instead, the property is just left empty with a value of the null set.

Write access may also be restrict to, for example, a specific property. In the example, a user could be allowed to read the CreditCardNumber property value, but not be allowed to update it.

Customer customer = objectNamespace.Read(

“RetailCustomer”
);

Customer.CreditCardNumber = “2222-2222-2222-2222”;
// AccessDenied exception will occur here as we do not have the right to
change/write into the CreditCardNumber property
objectNamespace.Write(

“Ret

ailCustomer”,

customer );

Accordingly, the principles described herein permit for a structure for enforcing security in a distributed object model, and specific examples have been provided. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer network comprising:
a computing system for running an application;
an instantiation platform located remotely from the computing system and on which is instantiated a plurality of objects, at least one of which being used by the application; and
a security intervention mechanism intervening between the application and the object used by the application to provide security between the application and the object.

2. The computer network in accordance with claim 1, wherein the instantiation platform is distributed on multiple computing systems.

3. The computer network in accordance with claim 1, wherein the security intervention mechanism enforces an authentication of the application or a user of the application before providing the application access to the object.

4. The computer network in accordance with claim 1, wherein the security mechanism correlates access rights for the object to identities.

5. The computer network in accordance with claim 4, wherein at least one of the access rights is to execute a specific method of the object.

6. The computer network in accordance with claim 4, wherein at least one of the access rights is to access a specific property of the object.

7. A computer network in accordance with claim 6, wherein the specific property is itself an object.

8. A computer network in accordance with claim 7, wherein the security intervention mechanism also defines authorizations for the object that is the specific property.

9. The computer network in accordance with claim 1, wherein the security intervention mechanism enforces an encryption protocol for the object.

10. The computer network in accordance with claim 9, wherein the encryption protocol indicates whether or not a property value of a property of the object is encrypted.

11. The computer network in accordance with claim 9, wherein the encryption protocol indicates whether or not messages to or from the object are to be encrypted.

12. A computer program product comprising one or more computer-readable media having thereon computer-executable instructions that, when executed by one or more processors of the computing system, cause the computing system to perform the following:
an act of providing security intermediation between an application and plurality of objects that are instantiated remotely from the application, wherein the act of providing security intermediate for includes the following for each of at least some of the plurality of objects;
act of maintaining security information for the corresponding object; and
when receiving a function call for the corresponding object, an act of enforcing the security information.

13. The computer program product in accordance with claim 12, wherein the security information for the corresponding object includes authentication parameters for authenticating the application or a user of the application before providing access to the object.

14. The computer program product in accordance with claim 12, wherein the security information for the corresponding object correlates access rights for the corresponding object to identities.

15. The computer program product in accordance with claim 14, wherein at least one of the access rights is to execute a specific method of the object.

16. The computer program product in accordance with claim 14, wherein at least one of the access rights is to access a specific property of the object.

17. A computer program product in accordance with claim 16, wherein the specific property is itself an object.

18. The computer program product in accordance with claim 12, wherein the security information defines an encryption protocol for the object.

19. The computer program product in accordance with claim 18, wherein the encryption protocol indicates whether or not a property value of a property of the object is encrypted, and whether or not messages to or from the object are to be encrypted.

20. A computer program product comprising one or more computer-readable media having thereon computer-executable instructions that, when executed by one or more processors of the computing system, cause the computing system to perform the following:
an act of providing security intermediation between an application and plurality of objects that are instantiated remotely from the application, wherein the act of providing security intermediate for includes the following for each of at least some of the plurality of objects:
act of maintaining security information for the corresponding object; and
when receiving a function call for the corresponding object, an act of enforcing the security information, wherein the security information includes the following:
authentication parameters for authenticating the application or a user of the application before providing access to the object;
authorization parameters for correlates access rights for the corresponding object to identities, at least one or which being or including the application or the user of the application; and
an encryption protocol for the object.
